(19) United States
(12) Patent Application Publication
(10) Pub. No.: US 2025/0216264 A1
(43) Pub. Date: Jul. 3, 2025

(54) LIGHT SOURCE APPARATUS

(71) Applicant: Ushio Denki Kabushiki Kaisha, Tokyo (JP)

(72) Inventors: Shingo AKAI, Tokyo (JP); Hideyuki SERA, Tokyo (JP); Kazumasa UETSUKI, Tokyo (JP)

(73) Assignee: Ushio Denki Kabushiki Kaisha, Tokyo (JP)

(21) Appl. No.: 18/850,289

(22) PCT Filed: Dec. 27, 2022
(86) PCT No.: PCT/JP2022/048241

§ 371 Date: Sep. 24, 2024

(30) Foreign Application Priority Data
Mar. 25, 2022 (JP) 2022-049510

(51) Int. Cl. G01J 3/50; G01J 3/02

(52) U.S. Cl. CPC G01J 3/502; G01J 3/0208; G01J 3/0218

(57) ABSTRACT

A light source apparatus emits wavelength swept light. A pulsed light source generates broadband pulsed light. A divider spatially divides the broadband pulsed light according to wavelength, and outputs a plurality of divided light beams. Fibers cause different levels of delay to the plurality of divided light beams. A coupler includes a dispersive element, and multiplexes and outputs the light beams output from the plurality of fibers.

### BACKGROUND

### 1. Technical Field

The present disclosure relates to a light source apparatus and an optical measurement apparatus.

### 2. Description of the Related Art

Spectroscopic analysis has been widely used for component analysis or inspection of a target object. In the spectroscopic analysis, illumination light is cast on the target object, and a spectrum of an object light obtained as a result of illumination is measured. Optical characteristic such as reflection characteristic (wavelength dependence) or transmission characteristic is obtainable, from relation between spectra of the object light and the illumination light.

Wavelength sweep type spectroscopy has been known as one of methods for measuring the optical characteristics. A wavelength sweep type spectrometer generates wavelength swept light whose wavelength changes with time, and illuminates an object to be inspected with the light. The wavelength swept light is given by a pulse or a pulse train having one-to-one correspondence between time and wavelength. Such wavelength swept light is illuminated on the object to be inspected, and a time-axis waveform of the resultant light is detected with a photodetector. An output waveform of the photodetector represents a spectrum whose time axis corresponds to wavelength.

Patent Literature 1 (JP2020-159973A) discloses a light source apparatus for a spectrometric apparatus based on a wavelength sweep style. FIG. 1 is a drawing illustrating a prior light source apparatus 200R. The light source apparatus 200R includes a pulsed light source 210, a divider 220, n pieces (n≥2) of fibers 230_1 to 230_n, and a coupler 240. The divider 220 has an arrayed waveguide grating (AWG) 222, through which pulsed light emitted from the pulsed light source 210 is divided into n light beams according to wavelength. The plurality of n fibers 230_1 to 230_n gives different delays to the n light beams divided by the divider 220. The coupler 240 spatially overlaps the light beams emitted from n fibers 230_1 to 230_n so as to be illuminated on the same illumination area. The divider 220 in Patent Literature 1 is structured to contain the AWG 222. Meanwhile, an exemplary structure of the coupler 240 ever disclosed contains an AWG 242, similarly to the divider 220.

The present inventors examined the light source apparatus 200R in FIG. 1, to find a problem below.

FIG. 2 is a drawing illustrating transmittance η of the AWGs 222, 242. FIG. 2 illustrates the transmittance η of one waveguide that corresponds to a divisional wavelength band centered at 1092 nm, from among the plurality of waveguides formed on the AWGs 222, 242. The transmittance η of the AWG that corresponds to one waveguide becomes maximum at the center wavelength (normalized herein to 1), and decreases as it departs from the center wavelength. The transmittance η herein is assumed to follow the Gaussian distribution.

In the light source apparatus 200R illustrated in FIG. 1, light in a certain divisional wavelength band passes through the AWG 222 in the divider 220 and the AWG 242 in the coupler 240. Now, the total transmittance would significantly decrease, if there is a shift between the peak wavelength of the AWG 222 in the divider 220 and the peak wavelength of the AWG 242 in the coupler 240. The peak wavelengths of the AWG 222 in the divider 220 and the peak wavelength of the AWG 242 in the coupler 240, therefore, need to be precisely matched. This can increase the cost.

Even with the peaks of the two AWGs successfully matched, the total transmittance of the two AWGs is given by η². Hence, the energy, or the area, of the light (η²) multiplexed by the coupler decreases down to 72%, from the energy (area) of the light (n) before being multiplexed.

In addition, light in a certain divisional wavelength band will have a narrowed wavelength width, after passage through the AWGs twice. Although the emitted light from the pulsed light source 210 has a broadband continuous spectrum, the emitted light from the light source apparatus 200R will have a discrete spectrum, if wavelength width for every divisional wavelength band of the AWG becomes narrower. The emitted light from the light source apparatus 200R, if given by the discrete spectrum, will have wavelengths that cannot be illuminated on the target object. In other words, the measurement will be disabled at some wavelengths, thus degrading performance of the spectrometer.

Moreover, the maximum transmittance η of one divisional wavelength band will actually become smaller than 1, due to coupling loss between the fibers and the AWG in the coupler, and waveguide loss in the bent waveguide on the AWGs. This can degrade efficiency of the light source apparatus 200R.

These issues have been independently recognized by the present inventors, and should not be regarded as common recognition by those skilled in the art.

### SUMMARY

The present disclosure has been made considering the aforementioned problems, and an exemplary object of an aspect of which is to provide a light source apparatus capable of solving at least one of the problems that can occur in a light source apparatus with use of an AWG as a coupler, and to provide an optical measurement apparatus with use of the same.

One aspect of the present disclosure relates to a light source apparatus that generates wavelength swept light. The light source apparatus has a pulsed light source structured to emit pulsed light; a divider structured to spatially divide the pulsed light according to wavelength, and to output a plurality of divided light beams; a plurality of fibers structured to cause different levels of delay to the plurality of divided light beams; and a coupler having a dispersive element, and being structured to multiplex the light beams output from the plurality of fibers.

Note that also free combinations of these constituents, and also any of the constituents and expressions exchanged among the method, apparatus and system and so forth, are valid as the embodiments of the present invention.

### BRIEF DESCRIPTION OF DRAWINGS

Embodiments will now be described, by way of example only, with reference to the accompanying drawings which are meant to be exemplary, not limiting, and wherein like elements are numbered alike in several Figures, in which:

FIG. 1 is a drawing illustrating a prior light source apparatus;

FIG. 2 is a drawing illustrating transmittance η of an AWG;

FIG. 3 is a block diagram illustrating a basic structure of an optical measurement apparatus according to an embodiment;

FIG. 4 is a drawing illustrating wavelength swept light;

FIG. 5 is a drawing explaining spectroscopy with use of the optical measurement apparatus illustrated in FIG. 3;

FIG. 6 is a drawing illustrating a light source apparatus according to First Embodiment;

FIG. 7 contains drawings illustrating efficiency of a coupler with use of a diffraction grating (dispersive element);

FIG. 8 contains drawings illustrating efficiency of a prior coupler with use of an AWG;

FIG. 9 is a drawing illustrating an exemplary specific structure of a coupler;

FIGS. 10A and 10B are drawings illustrating beam profiles of wavelength swept light obtained without and with a cylindrical lens, respectively;

FIG. 11 is a plan view of an optical fiber array;

FIG. 12 is an exploded perspective view illustrating the optical fiber array; and

FIG. 13 is a drawing illustrating a light source apparatus according to Second Embodiment.

### DETAILED DESCRIPTION

### Outline of Embodiments

Some exemplary embodiments of the present disclosure will be outlined. This outline will provide introduction into the detailed description that follows, and will brief some concepts of one or more embodiments for basic understanding thereof, without limiting the scope of the invention or disclosure. Also note this summary is not a comprehensive overview of all possible embodiments, and thus does not limit the essential components of the embodiments. For convenience, the term “one embodiment” may be used to designate a single embodiment (example or modified example), or a plurality of embodiments (Examples or Modified Examples) disclosed in the present specification.

The light source apparatus according to an embodiment generates wavelength swept light. The light source apparatus has a pulsed light source structured to emit pulsed light; a divider structured to spatially divide the pulsed light according to wavelength, and to output a plurality of divided light beams; a plurality of fibers structured to cause different levels of delay to the plurality of divided light beams; and a coupler having a dispersive element, and being structured to multiplex the light beams output from the plurality of fibers.

This structure will enjoy at least one advantage arise from the effects below.
Disuse of the AWG for the coupler no longer requires careful selection of components having been necessary for the AWGs both in the divider and the coupler.
Disuse of the AWG for the coupler can prevent narrowing of the wavelength width. Spectrometry with use of wavelength swept light can reduce wavelength ranges in which the measurement is disabled, and can improve the measurement accuracy.
Use of the AWG for the coupler will cause unignorable coupling loss between the fiber and the AWG, and unignorable waveguide loss in the AWG, meanwhile use of the dispersive element will be free of such losses in principle, whereby the efficiency may be improved.

The dispersive element herein means an optical element that spatially causes wavelength dispersion. The dispersive element includes diffraction grating that causes color dispersion due to coherence of light, and prism that causes color dispersion due to wavelength dependence of refractive index. AWG is, however, not included.

In one embodiment, the coupler may include, besides the dispersive element, an optical system structured to collimate the plurality of light beams output from the plurality of fibers, and to let the light beams enter the dispersive element at different incident angles according to wavelength.

In one embodiment, the principal rays of the plurality of light fluxes emitted from the output ends of the plurality of fibers may be aligned in parallel.

In one embodiment, the dispersive element may be a diffraction grating. The diffraction grating may be of transmission type or reflection type. In one embodiment, the dispersive element may be a prism.

In one embodiment, the optical system may be a Köhler lens system.

In one embodiment, the coupler may further have a cylindrical lens structured to receive the light beams output from the dispersive element, and having a power in a direction of wavelength dispersion of the dispersive element. This successfully suppresses the beam spreading of the wavelength swept light emitted from the coupler.

The optical measurement apparatus of one embodiment may have the light source apparatus structured to emit wavelength swept light for an object; and a light receiver structured to measure object light obtained by illuminating the object with the wavelength swept light.

### EMBODIMENTS

The present disclosure will be explained below on the basis of preferred embodiments, referring to the attached drawings. All constituents, members and processes illustrated in the individual drawings will be given same reference numerals, so as to properly avoid redundant explanations. The embodiments are merely illustrative, and are not restrictive about the disclosure. All features and combinations thereof described in the embodiments are not always essential to the disclosure.

Dimensions (thickness, length, width, etc.) of the individual members illustrated in the drawings may be appropriately enlarged or shrunk for easy understanding. Furthermore, the dimensions of the plurality of members do not necessarily indicate the dimensional relationship among them, so that a certain member A, if depicted thicker than another member B in a drawing, may even be thinner than the member B.

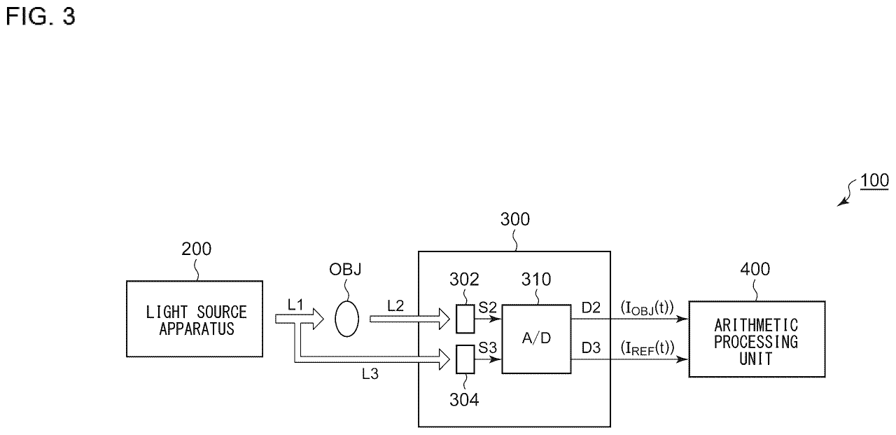

FIG. 3 is a block diagram illustrating a basic structure of an optical measurement apparatus 100 according to an embodiment. The optical measurement apparatus 100 is a wavelength swept type spectrometer structured to measure a spectrum of an object OBJ, and mainly includes a light source apparatus 200, a light receiver 300, and an arithmetic processing unit 400. Although some drawings will occasionally depict the light source apparatus 200, the light receiver 300 or the like as a block for simplicity, this does not mean that any components constituting each device are enclosed in a single enclosure.

The light source apparatus 200 illuminates the object OBJ with a wavelength swept light L1 whose wavelength changes with time. The wavelength swept light L1 has a one-to-one correspondence between time and wavelength. This can be expressed that the wavelength swept light L1 has “uniqueness of wavelength”.

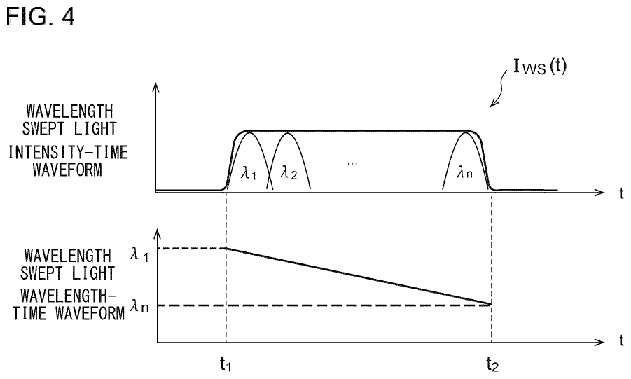

FIG. 4 is a drawing illustrating wavelength swept light L1. The upper tier of FIG. 4 illustrates intensity (time waveform) I_{WS}(t) of the wavelength swept light L1, and the lower tier illustrates a temporal change in wavelength λ of the wavelength swept light L1. The wavelength swept light L1 in this example is given by a single pulse, having dominant wavelength λ₁ at the leading edge, and dominant wavelength λₙ at the trailing edge. The wavelength varies with time within one pulse between λ₁ and λₙ. The wavelength swept light L1 in this example is a positively chirped pulse (λ₁>λₙ) whose frequency increases with time, in other words, whose wavelength shortens with time. Note that the wavelength swept light L1 may alternatively be a negatively chirped pulse whose wavelength becomes longer with time (λ₁<λₙ). The wavelength swept light L1 may alternatively be a pulse train, as described later.

Referring now back to FIG. 3. The light receiver 300 receives light (object light) L2 obtained as a result of illuminating the object OBJ with the wavelength swept light L1. The object light L2 may be reflected light or transmitted light. The light receiver 300 includes photosensors 302, 304 such as photodiodes, an A/D converter 310, an optical system (not illustrated), and so forth. The object light L2 is detected by the photosensor 302. A part of the wavelength swept light L1 emitted from the light source apparatus 200 is extracted as a reference light L3 into another path, with use of an optical element such as beam splitter, and detected by the photosensor 304.

The A/D converter 310 converts output signals S2, S3 from the photosensors 302, 304 respectively, into digital signals D2, D3, respectively. A time waveform I_{OBJ}(t) of the object light L2 given by the digital signal D2, and a time waveform I_{REF}(t) of the reference light L3 given by the digital signal D3 are taken into the arithmetic processing unit 400.

In the wavelength sweep type spectroscopy, the wavelength swept light L1 has a one-to-one correspondence between time and the wavelength. Such correspondence is also owned by the reference light L3 as a matter of course, and also inherited by the object light L2. With use of this correspondence between time and wavelength, the arithmetic processing unit 400 converts the time waveform I_{OBJ}(t) of the object light L2 into a spectrum I_{OBJ}(λ) in terms of frequency domain. The arithmetic processing unit 400 also converts the time waveform I_{REF}(t) of the reference light L3 into a spectrum followed by appropriate scaling, to calculate a reference spectrum I_{REF}(λ).

The processing by the arithmetic processing unit 400 is not particularly limited. For example, the arithmetic processing unit 400 can calculate transmittance T(λ) of the object OBJ, from the reference spectrum I_{REF}(λ) and the spectrum I_{OBJ}(λ) of the object light L2. The same applies to reflectance R(λ).

$$\begin{matrix}T ( λ ) = {I}_{OBJ} ( λ ) / {I}_{R E F} ( λ ) \\ R ( λ ) = {I}_{OBJ} ( λ ) / {I}_{R E F} ( λ )\end{matrix}$$

If the wavelength swept light L1 is stable enough, the wavelength swept light L1 preliminarily measured may be used as the reference spectrum I_{REF}(λ).

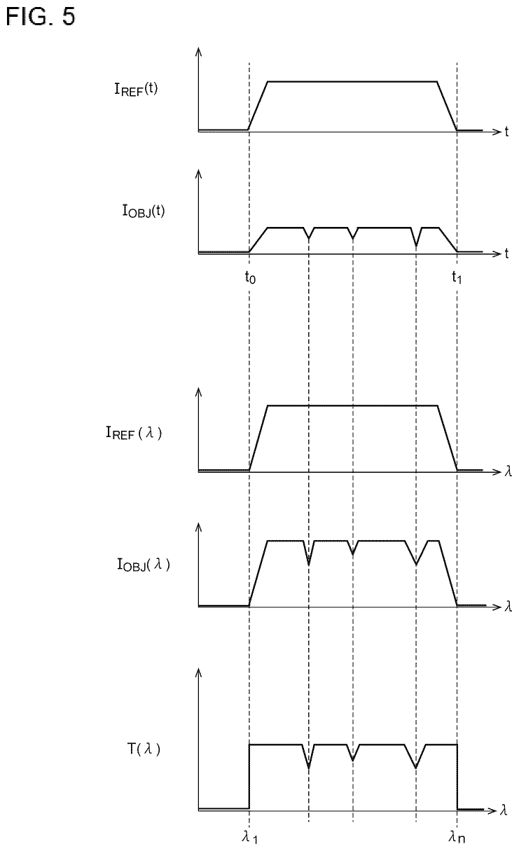

FIG. 5 is a drawing explaining spectroscopy with use of the optical measurement apparatus 100 illustrated in FIG. 3. Since the wavelength swept light L1 has the one-to-one correspondence between time t and wavelength λ as described previously, so that the time waveform I_{REF}(t) may be converted to the spectrum I_{REF}(λ) in terms of frequency domain.

Also the time waveform I_{OBJ}(t) of the object light L2 will have the one-to-one correspondence between time t and wavelength λ. The arithmetic processing unit 400 can therefore convert the waveform I_{OBJ}(t) of the object light L2 given by the output of the light receiver 300, into the spectrum I_{OBJ}(A) of the object light L2.

The arithmetic processing unit 400 can calculate transmittance T(λ) of the OBJ from I_{OBJ}(λ)/I_{REF}(λ), which is a ratio of two spectra I_{OBJ}(λ) and I_{REF}(λ).

Given that the relation between time t and wavelength λ in the wavelength swept light L1 is expressed by a function λ=f(t). Most simply, the wavelength λ varies linearly with time t according to a linear function. Lowering of the time waveform I_{OBJ}(t) of the object light L2 at a certain point in time tₓ means that the transmission spectrum T(λ) has an absorption spectrum at wavelength λₓ=f(tₓ).

Note that the processing by the arithmetic processing unit 400 is not limited thereto. The transmission spectrum T(λ) may be calculated alternatively by calculating T(t)=I_{OBJ}(t)/I_{REF}(t), which is a ratio of two time waveforms I_{OBJ}(t) and I_{REF}(t), and then by converting a variable t of the time waveform T(t) into A.

The basic structure and operations of the optical measurement apparatus 100 have been described. Next, a structure of the light source apparatus 200 will be explained.

### First Embodiment

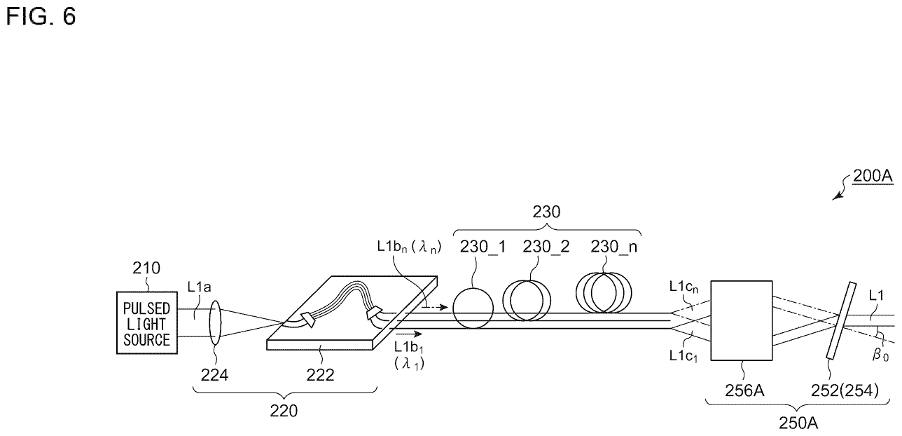

FIG. 6 is a drawing illustrating a light source apparatus 200A according to First Embodiment. The light source apparatus 200A includes the pulsed light source 210, the divider 220, n pieces (n≥2) of fibers 230_1 to 230_n (collectively referred to as a fiber group 230), and a coupler 250A.

The pulsed light source 210 emits broadband pulsed light L1a having a broadband continuous spectrum. Spectrum of the broadband pulsed light L1a is continuous typically within the wavelength region from 900 nm to 1300 nm, at least over a 10 nm range, preferably over a 50 nm range, and more preferably over a 100 nm range. The wavelength region of the broadband pulsed light L1a may only be wide enough to cover a range necessary for the spectroscopy.

The pulsed light source 210 may typically contain an ultrashort pulse laser and a nonlinear element. The ultrashort pulse laser is exemplified by gain-switched laser, microchip laser, and fiber laser.

The nonlinear element further widens the spectral width of the ultrashort pulse generated by the ultrashort pulse laser, by way of a nonlinear phenomenon. The nonlinear element is preferably a fiber, to which photonic crystal fiber or other nonlinear fiber is applicable. Mode of the fiber, although preferably single mode, may alternatively be multimode, if a sufficient level of nonlinearity is obtainable.

The pulsed light source 210 usable herein may be other broadband pulsed light source, such as superluminescent diode (SLD).

The broadband pulsed light L1a output from the nonlinear element has a pulse width in the order of femtoseconds to nanoseconds. The divider 220, the fiber group 230, and the coupler 250A receive the broadband pulsed light L1a, and convert the light into the wavelength swept light L1.

The divider 220 contains the arrayed waveguide grating (AWG) 222 and a lens 224. The lens 224 condenses the broadband pulsed light L1a emitted from the pulsed light source 210 on the incident ends of the AWG 222.

The AWG 222 spatially divides the broadband pulsed light L1a into a plurality of n light beams (referred to as divided light beams) L1b₁ to L1bₙ according to the wavelength, and outputs the light beams. The number of division (the number of channels) n is equal to the number of fibers 230. The number of channels n may typically 4, 8, 16, 32, 64 or 128. Letting the wavelength of the i-th (1≤i≤n) divided light beam be λᵢ. Since each of the divided light beams L1b₁ to L1bₙ, which is not a single spectrum, has a certain wavelength width, so that λᵢ is used to represent a wavelength band of L1bᵢ for convenience, rather than a single wavelength, and even occasionally represents the center wavelength of the wavelength band.

The divided light beams L1b₁ to L1bₙ output from the AWG 222 are guided to the fiber group 230_1 to 230_n. More specifically, the i-th divided light beam L1bᵢ is coupled to an input end of the corresponding fiber 230_i.

Assuming now the broadband pulsed light L1a before being divided is a positive chirp pulse (up-chirp pulse) whose frequency increases (wavelength decreases) with time. That is, the pulse contains a component having the longest wavelength λ₁ at the front edge, and a component having the shortest wavelength λₙ at the rear edge.

The plurality of fibers 230_1 to 230_n have different lengths l₁ to lₙ. Assuming λ₁ as the longest wavelength and λₙ as the shortest wavelength, the wavelength swept light L1 may be given as a positive chirp pulse like the broadband pulsed light L1a, if a relation of l₁<l₂< . . . <lₙ holds. In an exemplary case with n=20, the lengths l₁ to lₙ of the fibers 230 may increase from 1 m to 20 m in one-meter increments.

The fibers 230_1 to 230_n can use the same fiber (same core and clad materials), without necessarily having different group delay characteristics for every wavelength. In this sense, the fiber 230 may use multi-mode fiber, which is advantageous in that any unintended nonlinear optical effect is avoidable.

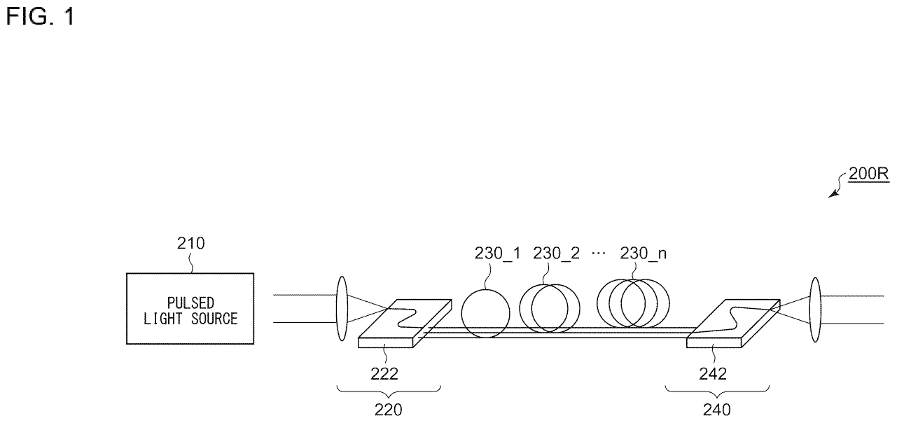

The coupler 250A spatially overlaps the plurality of divided light beams L1c₁ to L1cₙ given different delays by the fiber group 230, and outputs them. While the light source apparatus 200R illustrated in FIG. 1 uses the AWG for the coupler 240, this embodiment employs a dispersive element 252 in place of the AWG.

The coupler 250A has a diffraction grating 254 which is the dispersive element 252, and an optical system 256A. The diffraction grating 254, exemplified as being transmission-type in this embodiment, may alternatively be reflection-type.

Letting wavelength of light incident on the diffraction grating 254 be λ, incident angle be α, diffraction angle be β, order of diffraction be m, and period of the diffraction grating be d, the following equation holds.

$$d ( sin α - sin β ) = m λ \qquad ( 1 )$$

For the i-th divided light beam L1cᵢ, the equation below holds.

$$d ( sin {α}_{i} - sin {β}_{i} ) = m {λ}_{i} \qquad ( 2 )$$

All divided light beams L1c₁ to L1cₙ are output while being spatially overlapped, if all diffraction angles β₁ to βₙ are equal. Such diffraction angle is denoted as β₀. Incident angle αᵢ of the divided light beam L1cᵢ having the wavelength λᵢ may only satisfy the equation below.

$${α}_{i} = arc sin ( sin {β}_{0} + m {λ}_{i} / d ) \qquad ( 3 )$$

The order of diffraction is selectable so as to maximize the diffraction efficiency, which is typically given by m=1.

The output end of each of the fibers 230_1 to 230_n can be regarded as a point light source, from which each of the divided light beams L1c₁ to L1cₙ is emitted as diffused light (spherical wave). The optical system 256A collimates each of the divided light beams L1c₁ to L1cₙ, and guides them to the diffraction grating 254, which is the dispersive element 252, at the incident angles di to an that satisfy the equation (3).

The diffraction grating 254 thus emits the plurality of divided light beams L1c₁ to L1cₙ in the same direction. The plurality of divided light beams L1c₁ to L1cₙ emitted from the diffraction grating 254 are spatially overlapped, and are illuminated on an object as the wavelength swept light L1.

The structure of the light source apparatus 200A has been described. Next, the advantage will be explained.

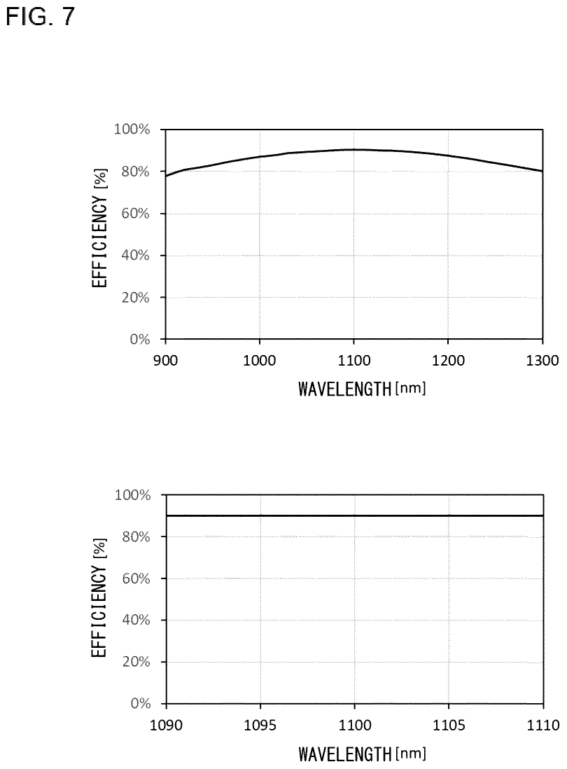

FIG. 7 contains drawings illustrating efficiency of the coupler 250A that uses the diffraction grating 254 (dispersive element 252). The lower tier of FIG. 7 presents a partial enlargement of the upper tier in the wavelength range from 1090 nm to 1110 nm, demonstrating a flat efficiency over a 20 nm range.

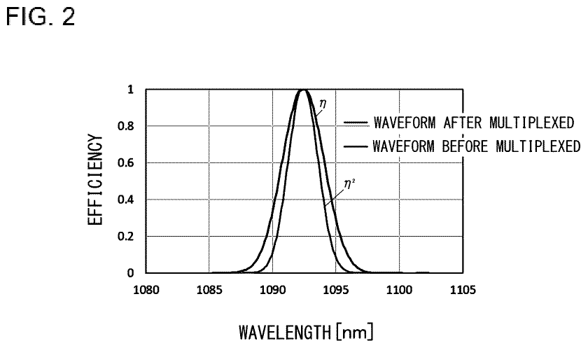

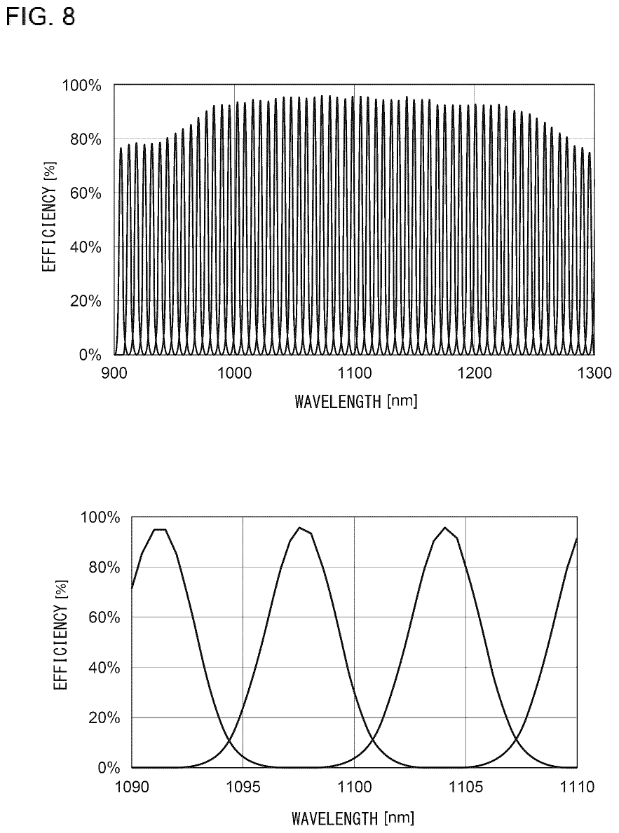

FIG. 8 contains drawings illustrating efficiency of a prior coupler 240 with use of an AWG. As has been described previously, the transmittance of the AWG follows the Gaussian distribution as illustrated in FIG. 2, so that the coupler 240 as a whole demonstrates a comb-like (discrete) transmittance. In contrast, the coupler 250A with use of the diffraction grating 254 gives transmittance that is continuous over a wide wavelength range as illustrated in FIG. 7.

Use of the prior coupler 240 has been required to match the peak wavelengths of the respective wavelength bands between the divider 220 and the coupler 240. That is, the AWG of the divider 220 and the AWG of the coupler 240 have needed to be carefully selected so as to have the same characteristics, making the design more difficult and cost-consuming. In contrast, the coupler 250A in this embodiment demonstrates the flat efficiency, and can therefore remove restrictions on the AWG 222 used in the divider 220. This can expand options of choice of components, and can reduce the cost.

In the prior coupler 240, the light transmits through the AWGs twice. As has been illustrated in FIG. 2, the spectrum η after transmitted through the AWG of the divider 220 and before being multiplexed follows the Gaussian distribution. With the efficiency η of the Gaussian distribution further multiplied by the AWG of the coupler 240 in the subsequent stage, the spectrum η² after the multiplexing will become narrower than the Gaussian distribution η before the multiplexing.

Narrowing of the wavelength range in spectrometry causes a deep valley between wavelength peaks. Such deep valley means that the intensity of light at the corresponded wavelength is significantly low. Hence the object will have only light at discrete wavelengths incident thereon, out of the measurement wavelength range from 900 nm to 1300 nm (light at a wavelength corresponded to each valley will not be incident thereon). This means that information is not obtainable at the valley wavelength, eventually reducing the volume of obtainable information, and degrading the measurement accuracy.

In contrast, the coupler 250A in this embodiment has the flat efficiency without wavelength dependence. That is, the spectrum will not be narrowed even after passing through the coupler 250A, with the Gaussian distribution n maintained. Therefore, the light will have larger intensity between the peaks as compared with the prior art, successfully keeping the light intensity kept at a level necessary for the spectrometry. Thus, the measurement accuracy can be improved as compared with the prior art.

The prior art has also caused lowering of energy of the multiplexed light in the coupler 240, approximately down to 72% from energy of the light before being multiplexed. This is attributable not only to the aforementioned efficiency of the AWG, but also to coupling loss between the fibers and the AWG, and propagation loss and bending loss in the waveguide. In contrast in this embodiment, the coupler 250A demonstrates an efficiency exceeding 90% at around wavelength 1100 nm as illustrated in FIG. 7, thus enabling multiplexing with higher efficiency as compared with the coupler 240.

Next, a specific structure of the constituent elements of the light source apparatus 200A will be described.

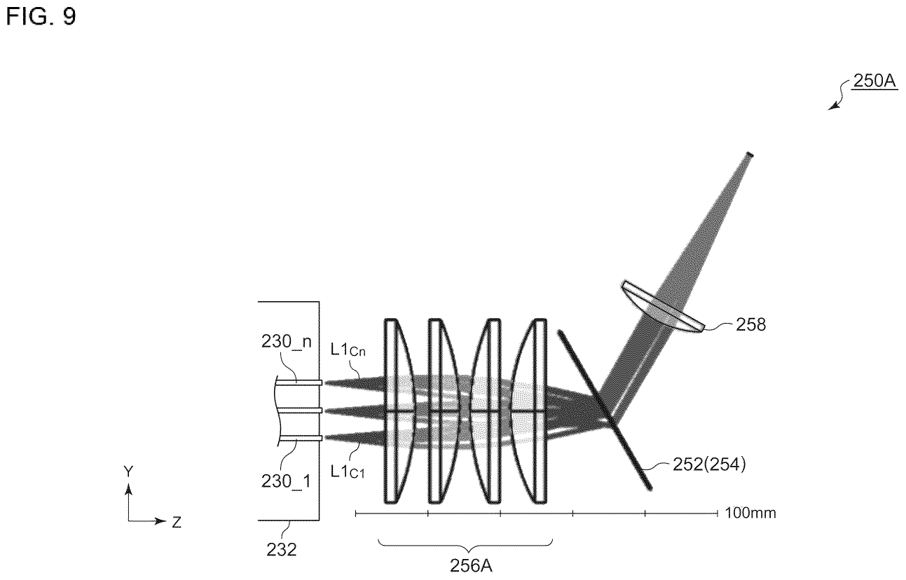

FIG. 9 is a drawing illustrating an exemplary specific structure of the coupler 250A. As has been described previously, each of the divided light beams L1c₁ to L1Cₙ emitted from the fiber group 230 is a diffused light beam. Assuming now the fibers 230_1 to 230_n are parallel at the output end, and therefore the principal light beams of fluxes of the divided light beams L1c₁ to L1cₙ are parallel. The optical system 256A in this case may be constituted with a Köhler lens system (Köhler illumination system). The optical system 256A typically contains four lenses. Position of the output end of each fiber 230_1 to 230_n relative to the optical system 256A is designed so that the incident angles α₁ to αₙ on the diffraction grating 254 satisfy the equation (3). Note that the structure of the optical system 256A is not limited to that illustrated in FIG. 9.

Spectrum of each of the divided light beams L1c₁ to L1cₙ typically has a wavelength width of approximately 3 to 5 nm, which may be occasionally wider. With the light thus having a wide wavelength range incident on the diffraction grating 254, the diffracted light extends in a direction perpendicular to the direction of the grating line (direction of wavelength dispersion). That is, the wavelength swept light L1 multiplexed by the diffraction grating 254 will have a beam diameter that expands in a direction perpendicular to the direction of the grating line. Such beam expansion may occasionally be undesirable depending on applications.

The coupler 250A illustrated in FIG. 9 therefore has a cylindrical lens 258 that receives the light emitted from the diffraction grating 254. The cylindrical lens 258 is inserted between the diffraction grating 254 and the object. The cylindrical lens 258 has a power in a direction of wavelength dispersion of the diffraction grating 254.

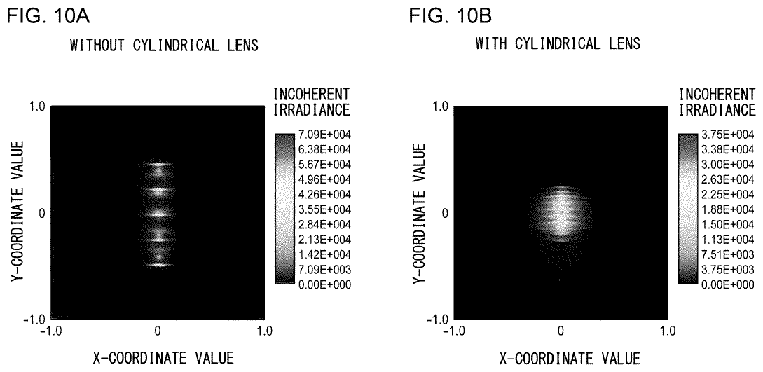

FIGS. 10A and 10B are drawings illustrating beam profiles of the wavelength swept light L1 obtained without and with the cylindrical lens, respectively. Insertion of the cylindrical lens 258 can suppress the wavelength swept light L1 from spreading in the direction of wavelength dispersion (direction of Y-coordinate in FIG. 10).

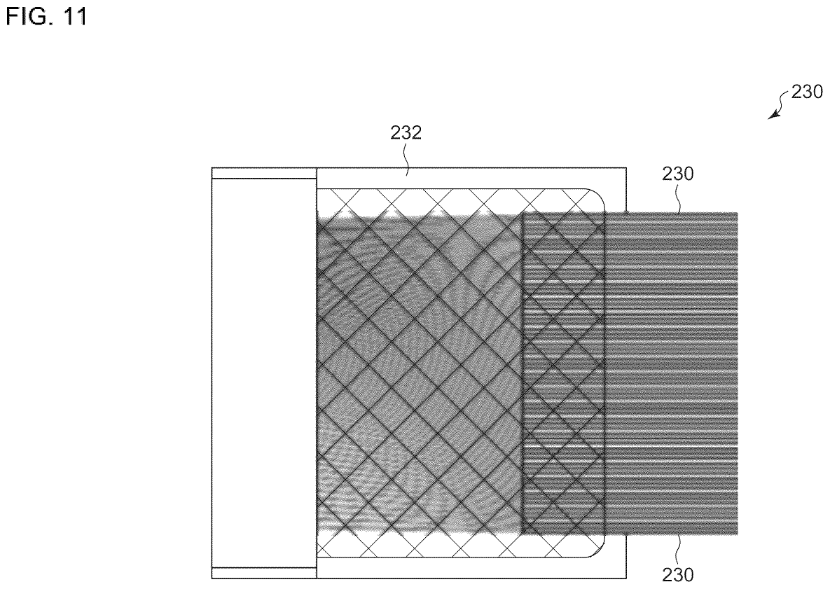

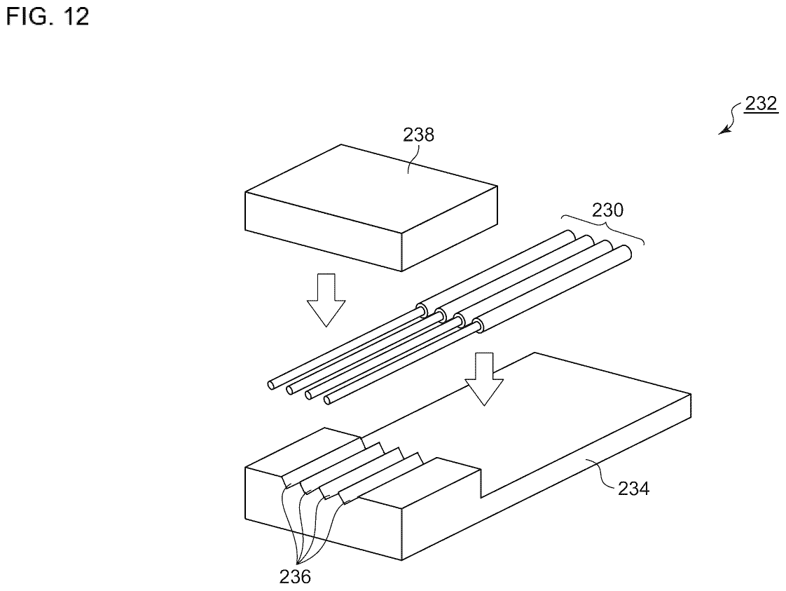

Referring now back to FIG. 9. The output ends of the plurality of fibers 230_1 to 230_n need to be precisely positioned. An optical fiber array 232 may be used for the positioning. FIG. 11 is a plan view illustrating the optical fiber array 232. FIG. 12 is an exploded perspective view illustrating the optical fiber array 232.

The optical fiber array 232 has a plurality of V-shaped grooves 236 to which the fibers 230 are fitted, formed on the substrate 234 by precision processing. The plurality of fibers 230 are arranged and fixed in a row, by fitting the fibers 230 in the V-shaped grooves 236 one by one. The space between the V-shaped grooves 236 may be formed with micrometer precision, and the position of each V-shaped groove 236 may be designed according to the wavelength λᵢ of the divided light beam L1cᵢ that propagate through the corresponding fiber 230_i. After fitting the fibers 230 into the V-shaped grooves 236, a cover 238 is attached from above to fix the fibers 230.

### Second Embodiment

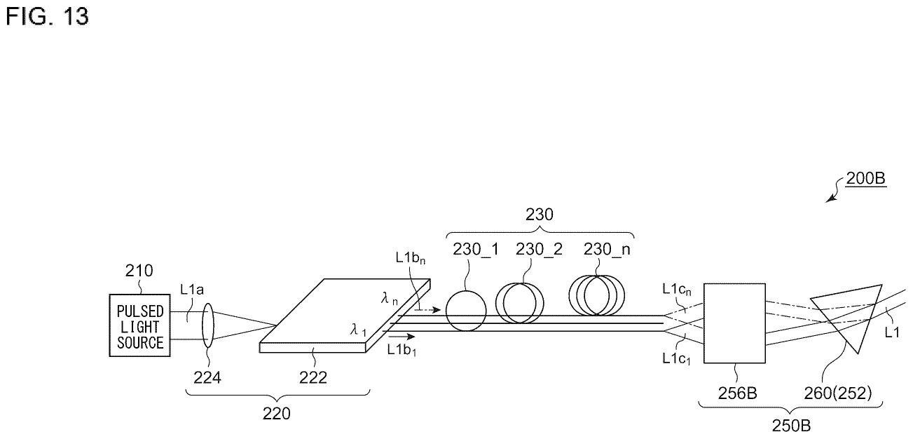

FIG. 13 is a drawing illustrating a light source apparatus 200B according to Second Embodiment. In the light source apparatus 200B, a structure of a coupler 250B is different from that of the coupler 250A illustrated in FIG. 6. The coupler 250B has a prism 260, as the dispersive element 252.

An optical system 256B collimates each of the divided light beams L1c₁ to L1cₙ emitted from the fibers 230_1 to 230_n, and guides them to the prism 260 at appropriate angles and appropriate positions. Hence the prism 260 can output the wavelength swept light L1 as a result of spatial multiplexing of the plurality of divided light beams L1c₁ to L1cₙ.

### Modified Example

Arrangement of the output ends of the fibers 230_1 to 230_n, although explained in the embodiments as being parallel, is not limited thereto. The output ends of the fibers 230_1 to 230_n may be arranged non-parallel at angles conforming to di to an. The optical system 256 in this case is dedicated to collimation only.

Having described the embodiments according to the present disclosure with use of specific terms, the description is merely illustrative for better understanding, and by no means limits the disclosure or the claims. The scope of the present invention is defined by the claims, and therefore encompasses any embodiment, example, and modified example having not been described above.

1. A light source apparatus structured to emit wavelength swept light, the apparatus comprising:
a pulsed light source structured to emit pulsed light;
a divider structured to spatially divide the pulsed light according to wavelength, and to output a plurality of divided light beams;
a plurality of fibers structured to cause different levels of delay to the plurality of divided light beams; and
a coupler having a dispersive element, and being structured to multiplex the light beams output from the plurality of fibers.

2. The light source apparatus according to claim 1, wherein
the coupler includes, besides the dispersive element, an optical system structured to collimate the plurality of light beams output from the plurality of fibers, and to let the light beams enter the dispersive element at different incident angles according to wavelength.

3. The light source apparatus according to claim 2, wherein the dispersive element is a diffraction grating.

4. The light source apparatus according to claim 2, wherein the dispersive element is a prism.

5. The light source apparatus according to claim 2, wherein the optical system is a Köhler lens system.

6. The light source apparatus according to claim 1, wherein the coupler further comprises a cylindrical lens structured to receive light beams output from the dispersive element, and having a power in a direction of wavelength dispersion of the dispersive element.

7. An optical measurement apparatus comprising:
the light source apparatus according to claim 1, structured to emit wavelength swept light; and
a light receiver structured to measure object light obtained by illuminating an object with the wavelength swept light.
